(19) United States
(12) Patent Application Publication
(10) Pub. No.: US 2025/0226767 A1
(43) Pub. Date: Jul. 10, 2025

(54) INVERTER CIRCUIT

(71) Applicant: GS Yuasa International Ltd., Kyoto-shi, Kyoto (JP)

(72) Inventor: Akiteru CHIBA, Kyoto-shi, Kyoto (JP)

(21) Appl. No.: 18/851,481

(22) PCT Filed: Mar. 28, 2023
(86) PCT No.: PCT/JP2023/012551

§ 371 Date: Sep. 26, 2024

(30) Foreign Application Priority Data
Mar. 29, 2022 (JP) 2022-054276

(51) Int. Cl. H02M 7/537; H02M 1/38; H02M 7/48

(52) U.S. Cl. CPC H02M 7/537; H02M 1/38; H02M 7/4815

(57) ABSTRACT

An inverter circuit (100) includes a series circuit connected in parallel to a DC power supply (Vin) and having a control switch (Q1) and a synchronous rectification switch (Q2) connected in series, a reactor (L) having one end connected to a connection point between the control switch (Q1) and the synchronous rectification switch (Q2), an output capacitor (Co) connected between a power line of the DC power supply (Vin) and another end of the reactor (L), and a control circuit that controls ON time (tonQ1) of the control switch (Q1) and ON time (tonQ2) of the synchronous rectification switch (Q2) so as to generate reverse current (Ir) in the reactor (L) in an entire range of an instantaneous value (VO) of AC output voltage (vo).

### CROSS REFERENCE TO RELATED APPLICATIONS

This application is a National Stage Application, filed under 35 U.S.C. § 371, of International Application No. PCT/JP2023/012551, filed Mar. 28, 2023, which international application claims priority to and the benefit of Japanese Application No. 2022-054276, filed Mar. 29, 2022; the contents of both of which as are hereby incorporated by reference in their entireties.

### BACKGROUND

### Technical Field

The present invention relates to an inverter circuit capable of converting DC input voltage into AC output voltage of a predetermined frequency.

### Description of Related Art

In a conventional critical inverter circuit that performs synchronous rectification, zero voltage switching (ZVS) of a control switch has not been able to be performed unless a ratio between DC input voltage Vin and an instantaneous value VO of AC output voltage vo is equal to or more than a predetermined value (Vin≥2VO). Further, in the critical inverter circuit, since a switching frequency fs of a control switch and a synchronous rectification switch greatly changes according to a change in the instantaneous value VO of the AC output voltage vo, high efficiency has not been able to be obtained. Patent Document JP-A-62-178176 is cited for reference.

### BRIEF SUMMARY

One aspect of the present invention provides a high-efficiency inverter circuit in which zero voltage switching (ZVS) of a control switch can be performed in a wide range of an instantaneous value VO of AC output voltage vo, and a change in a switching frequency fs according to a change in the instantaneous value VO of the AC output voltage vo is small.

In order to solve the above problem, an inverter circuit according to one aspect of the present invention includes a series circuit in which a control switch and a synchronous rectification switch are connected in series, the series circuit being connected in parallel to the DC power supply, a reactor having one end connected to a connection point between the control switch and the synchronous rectification switch, an output capacitor that is connected between a power supply line of the DC power supply and another end of the reactor and outputs the AC output voltage to both ends, and a control circuit that performs control of turning off the control switch and turning on the synchronous rectification switch after turning on the control switch for first ON time, and turning off the synchronous rectification switch and turning on the control switch after turning on the synchronous rectification switch for second ON time so as to generate reverse current in the reactor in an entire range of an instantaneous value of the AC output voltage.

### BRIEF DESCRIPTION OF THE FIGURES

FIG. 1 is a diagram illustrating a step-down chopper circuit (a conceptual diagram illustrating a conventional inverter circuit).

FIG. 2 is a circuit diagram when a synchronous rectification switch Q2 of the step-down chopper circuit is turned off.

FIG. 3 is a diagram illustrating minimum reverse current with respect to an instantaneous value of AC output voltage in a case where a specific condition (parameter) is set in the step-down chopper circuit.

FIG. 4 is a diagram illustrating an envelope (solid line) of switching current and current (broken line) of AC output with respect to a phase (half cycle) of AC output voltage of the step-down chopper circuit.

FIG. 5 is a diagram illustrating a relationship between a phase (half cycle) of AC output voltage and a switching frequency.

FIG. 6 is a diagram illustrating a relationship between an instantaneous value of AC output voltage and reverse current in an inverter circuit employing System 1.

FIG. 7 is a diagram illustrating a relationship between an instantaneous value of AC output voltage and reverse current in the inverter circuit employing System 2.

FIG. 8 is a diagram illustrating an envelope (solid line) of switching current and AC output current (broken line) with respect to a phase (half cycle) of AC output voltage in the inverter circuit employing System 1.

FIG. 9 is a diagram illustrating an envelope (solid line) of switching current and AC output current (broken line) with respect to a phase (half cycle) of AC output voltage in the inverter circuit employing System 2.

FIG. 10 is a diagram illustrating a relationship between a phase (half cycle) of AC output voltage and a switching frequency in the inverter circuit employing System 1.

FIG. 11 is a diagram illustrating a relationship between a phase (half cycle) of AC output voltage and a switching frequency in the inverter circuit employing System 2.

FIG. 12 is a diagram illustrating an envelope (solid line) of switching current and AC output current (broken line) with respect to a phase (half cycle) of AC output voltage in the inverter circuit employing System 3.

FIG. 13 is a diagram illustrating a relationship between a phase (half cycle) of AC output voltage and a switching frequency in the inverter circuit employing System 3.

FIG. 14 is a time chart illustrating a waveform of switching current flowing through a first switch Q1 and a second switch Q2 when switching is made between on and off of the first switch Q1 and the second switch Q2 as in Systems 1 to 3.

FIG. 15 is a circuit diagram of the inverter circuit according to a first embodiment.

FIG. 16 is a circuit diagram of the inverter circuit according to a second embodiment.

FIG. 17 is a circuit diagram of the inverter circuit according to a third embodiment.

FIG. 18 is a circuit diagram of the inverter circuit according to a fourth embodiment.

### DETAILED DESCRIPTION OF VARIOUS EMBODIMENTS

Hereinafter, an inverter circuit according to an embodiment of the present invention will be described in detail with reference to the drawings.

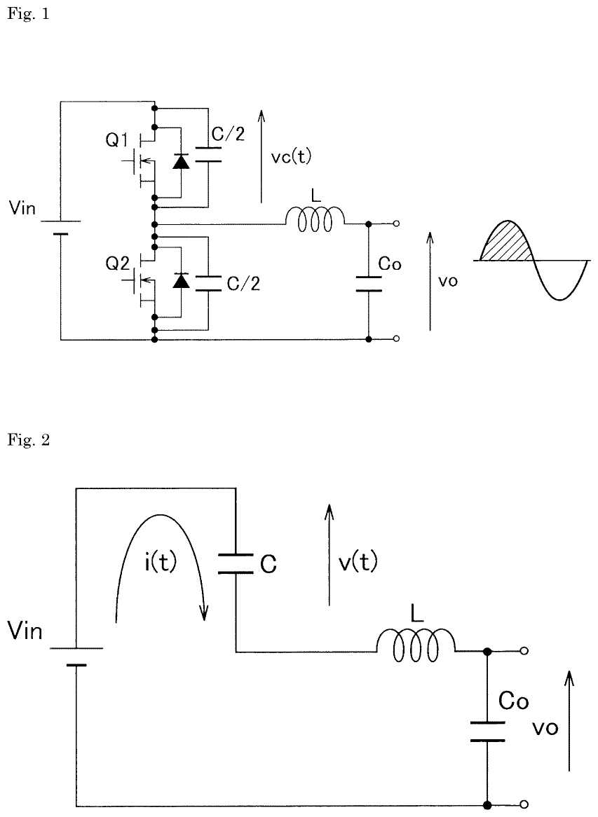

First, basic operation of a conventional inverter circuit will be described with reference to a step-down chopper circuit of FIG. 1. In FIG. 1, Vin represents DC voltage, Q1 represents a control switch (first switch), Q2 represents a synchronous rectification switch (second switch), C/2 represents a capacitor, L represents a reactor, and Co represents an output capacitor. The step-down chopper circuit can output a positive half cycle of AC output voltage vo to the output capacitor Co. The capacitor C/2 includes parasitic capacity of each of the switches Q1 and Q2 or capacity of an external capacitor.

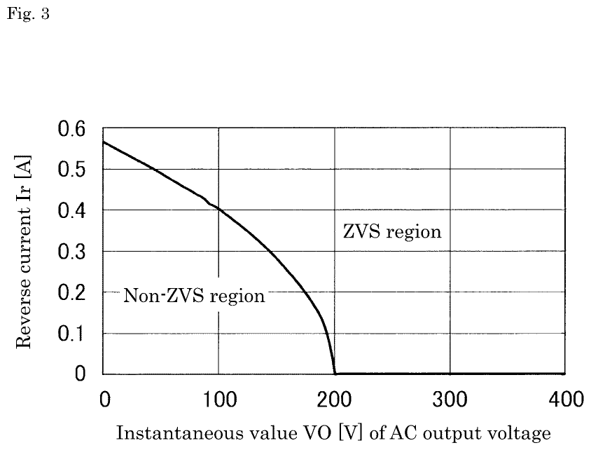

FIG. 2 is a circuit network when the first switch Q1 is turned on and the second switch Q2 is turned off in the step-down chopper circuit of FIG. 1. Two of the capacitors C/2 illustrated in FIG. 1 are assumed to have the same charge-discharge amount and collectively connected as a capacitor C in parallel to the first switch Q1.

A switching frequency fs (for example, several hundred kHz) of the switches Q1 and Q2 is sufficiently large as compared with a frequency fo (for example, 50 Hz) of the AC output voltage vo. For this reason, a value of the AC output voltage vo within each switching cycle of the switches Q1 and Q2 can be regarded as constant (direct current).

Current i(t) flowing through the circuit as indicated by an arrow in FIG. 2 is expressed by Formula 1 using voltage v(t) of the capacitor C. Here, t represents time.

$$\begin{matrix}[ Mathematical formula 1 ] & \\ \text{?} ( t ) = C \frac{dv ( \text{?} )}{\text{?}} & ( Formula 1 )\end{matrix}$$

$$\text{?} \text{indicates text missing or illegible when filed}$$

When reverse excitation current of a reactor L is Ir, current i(0) and the voltage v(t) at time t=0, that is, under an initial condition are expressed by Formula 2.

$$\begin{matrix}[ Mathematical formula 2 ] & \\ \{ \begin{matrix}\text{?} ( 0 ) = \text{?} \\ \text{?} ( 0 ) = \text{?}\end{matrix} & ( Formula 2 )\end{matrix}$$

$$\text{?} \text{indicates text missing or illegible when filed}$$

Further, a network equation of FIG. 2 is expressed by Formula 3.

$$\begin{matrix}[ Mathematical formula 3 ] & \\ Vin = \text{?} + L \frac{\text{?}}{\text{?}} + \text{?} & ( Formula 3 )\end{matrix}$$

$$\text{?} \text{indicates text missing or illegible when filed}$$

Formula 4 below is obtained from Formulas 1, 2, and 3.

$$\begin{matrix}[ Mathematical formula 4 ] & \\ \{ \begin{matrix}\text{?} \\ \text{?} \\ ω = \frac{1}{\sqrt{LC}}\end{matrix} & ( Formula 4 )\end{matrix}$$

$$\text{?} \text{indicates text missing or illegible when filed}$$

From Formula 4, a condition for obtaining reverse excitation current Ir (hereinafter, referred to as reverse current) with respect to the output voltage vo is obtained. Since at least the voltage v(t) needs to be 0 V or less, a condition as in Formula 5 is obtained.

$$\begin{matrix}[ Mathematical formula 5 ] & \\ \text{?} = \text{?} - \text{?} \sqrt{\frac{\text{?}}{\text{?}}} \text{?} & ( Formula 5 )\end{matrix}$$

$$\text{?} \text{indicates text missing or illegible when filed}$$

Formula 5 can be rewritten as Formula 6.

$$\begin{matrix}[ Mathematical formula 6 ] & \\ \{ \begin{matrix}\text{?} \\ θ = {tan}^{- 1} \text{?} \sqrt{\frac{L}{C}}\end{matrix} & ( Formula 6 )\end{matrix}$$

$$\text{?} \text{indicates text missing or illegible when filed}$$

In order to obtain the minimum reverse current Ir that satisfies the first equation of Formula 6, the first equation of Formula 6 only needs to be satisfied when a cosine function is minimum, that is, −1 (when Formula 7 below is satisfied).

$$\begin{matrix}[ Mathematical formula 7 ] & \\ \frac{\text{?}}{\sqrt{LC}} + θ = π & ( Formula 7 )\end{matrix}$$

$$\text{?} \text{indicates text missing or illegible when filed}$$

Therefore, the reverse current Ir only needs to satisfy Formula 8 below.

$$\begin{matrix}[ Mathematical formula 8 ] & \\ \text{?} \sqrt{\frac{C}{L} Vin ( Vin - \text{?} )} & ( Formula 8 )\end{matrix}$$

$$\text{?} \text{indicates text missing or illegible when filed}$$

For example, the minimum reverse current Ir with respect to the instantaneous value VO of the output voltage vo in a case of a condition shown in Formula 9 below is as shown in FIG. 3.

$$\begin{matrix}[ Mathematical formula 9 ] & \\ L = 100 uH & ( Formula 9 )\end{matrix}$$

$$C = 200 pF$$

$$Vin = 400 Vdc$$

Here, as shown in Formula 10, output power Po is set to 500 W, effective voltage Vrms of the AC output voltage vo is set to AC 200 V, an instantaneous value of AC output current io is expressed as IO, and an angular frequency of AC output current is expressed as ωo (=2πfo).

$$\begin{matrix}[ Mathematical formula 10 ] & \\ \text{?} = 500 W & ( Formula 10 )\end{matrix}$$

$$Vrms = 200 {V}_{rms}$$

$$IO = \sqrt{2} \frac{{P}_{0}}{\text{?}} sin \text{?}$$

$$\text{?} \text{indicates text missing or illegible when filed}$$

In a case where an instantaneous value of the AC output voltage vo is expressed as VO, it is not necessary to reverse current in order to perform zero voltage switching in a scope of 2VO≥Vin (=400 V). When the instantaneous value VO of the AC output voltage is in a scope of 200 V to 400 V, the reverse current Ir is zero.

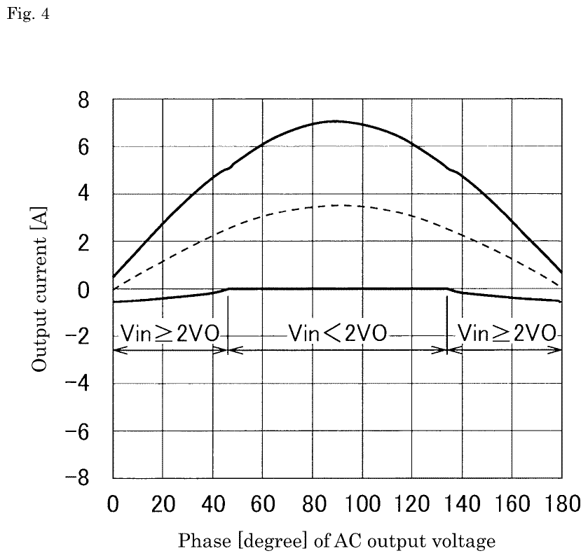

In AC output, when a parameter of Formulas 9 and 10 is used, an envelope of critical switching current is as shown by a solid line in FIG. 4. FIG. 4 illustrates only a phase of a half cycle of the AC output voltage vo, and current is reversed only in a section of a phase satisfying Vin≥2VO. In FIG. 4, a broken line indicates current of AC output (500 W/200 Vrms=2.5 Arms).

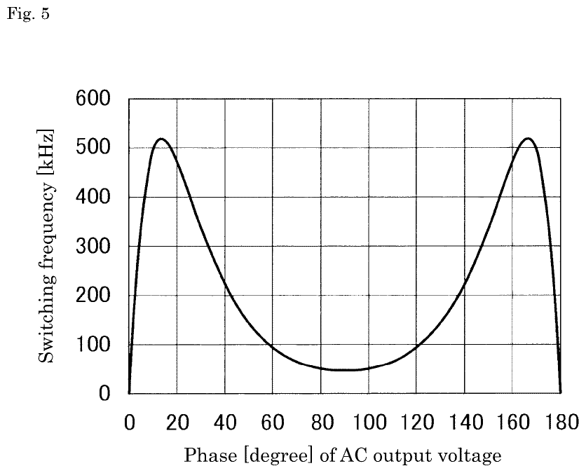

FIG. 5 illustrates a relationship between the switching frequency fs of the switches Q1 and Q2 and a phase of the AC output voltage vo corresponding to FIG. 4. As illustrated in FIG. 5, the switching frequency fs has a difference of about ten times between a maximum value and a minimum value. In particular, when a phase of the AC output voltage vo is small, switching current is small as shown in FIG. 4, but since the switching frequency fs is large as shown in FIG. 5, it is difficult to reduce switching loss.

A calculation formula used in FIGS. 4 and 5 is as described below.

(1) Under this condition when Vin<2VO, the control switch Q1 cannot perform zero voltage switching and performs hard switching. The reverse current Ir is zero as in Formula 11.

$$\begin{matrix}[ Mathematical formula 11 ] & \\ \text{?} r = 0 & ( Formula 11 )\end{matrix}$$

$$\text{?} \text{indicates text missing or illegible when filed}$$

ON time tonQ1 of the first switch Q1 is expressed by Formula 12.

$$\begin{matrix}[ Mathematical formula 12 ] & \\ \text{?} = \frac{2 L}{Vin - VO} \text{?} & ( Formula 12 )\end{matrix}$$

$$\text{?} \text{indicates text missing or illegible when filed}$$

ON time tonQ2 of the second switch Q2 is expressed by Formula 13.

$$\begin{matrix}[ Mathematical formula 13 ] & \\ \text{?} Q 2 = \frac{Vin - VO}{VO} \text{?} Q 1 & ( Formula 13 )\end{matrix}$$

$$\text{?} \text{indicates text missing or illegible when filed}$$

Further, dead time tdead from when the second switch Q2 is turned off to when the first switch Q1 is turned on is expressed by Formula 14 from Formulas 7 and 11.

$$\begin{matrix}[ Mathematical formula 14 ] & \\ tdead = π \sqrt{LC} & ( Formula 14 )\end{matrix}$$

Dead time from when the first switch Q1 is turned off to when the second switch Q2 is turned on may be omitted in the principle of synchronous rectification. Therefore, the reciprocal of the sum of Formulas 12, 13, and 14 is the switching frequency fs in the phase section of Vin<2VO in FIG. 4.

(2) Under this condition when Vin≥2VO, the first switch Q1 can perform zero voltage switching.

The reverse current Ir is expressed by Formula 15.

$$\begin{matrix}[ Mathematical formula 15 ] & \\ \text{?} = \sqrt{\frac{C}{\text{?}} Vin ( Vin - 2 VO )} & ( Formula 15 )\end{matrix}$$

$$\text{?} \text{indicates text missing or illegible when filed}$$

The ON time tonQ1 of the first switch Q1 is expressed by Formula 16.

$$\begin{matrix}[ Mathematical formula 16 ] & \\ tonQ 2 = \frac{2 L}{Vin - VO} in + \frac{2 \sqrt{LCVin ( Vin - 2 VO )}}{Vin - VO} & ( Formula 16 )\end{matrix}$$

The ON time tonQ2 of the second switch Q2 is expressed by Formula 17.

$$\begin{matrix}[ Mathematical formula 17 ] & \\ \text{?} Q 2 = \frac{Vin - VO}{VO} \text{?} Q 1 & ( Formula 17 )\end{matrix}$$

$$\text{?} \text{indicates text missing or illegible when filed}$$

Further, the dead time tdead from when the second switch Q2 is turned off to when the first switch Q1 is turned on is expressed by Formula 18 from Formulas 7 and 15.

$$\begin{matrix}[ Mathematical formula 18 ] & \\ \text{?} dead = \sqrt{LC} ( \text{?} - ta \text{?} \frac{\sqrt{Vin ( Vin - 2 VO )}}{VO} ) & ( Formula 18 )\end{matrix}$$

$$\text{?} \text{indicates text missing or illegible when filed}$$

Dead time from when the first switch Q1 is turned off to when the second switch Q2 is turned on may be omitted in the principle of synchronous rectification. Therefore, the reciprocal of the sum of Formulas 16, 17, and 18 is the switching frequency fs in the phase section of Vin≥2VO in FIG. 4.

As described above, in the conventional step-down chopper circuit (conventional inverter circuit), whether zero voltage switching (ZVS) can be performed or not is determined by a phase angle of AC output voltage, and particularly when digital control has been performed, a calculation formula has been complicated and a calculation amount has been large.

In the phase section in which the instantaneous value VO of the AC output voltage vo is Vin<2VO, the voltage v(t) of the capacitor C does not decrease to 0 V, the first switch Q1 performs hard switching, and switching current is also large in this section. For this reason, a switching loss increases, and it has been difficult to improve efficiency of the inverter circuit.

In view of the above, the present embodiment provides a low-loss critical inverter circuit capable of reliably performing zero voltage switching at all phase angles of AC output voltage. As a specific system for the above, first, two systems below will be described.

(System 1) By setting an ON period of the second switch Q2 so as to draw a reverse current envelope that increases and decreases according to a phase of the AC output voltage vo, a difference in the switching frequency fs is reduced to obtain high efficiency.

(System 2) By setting an ON period of the second switch Q2 so that a reverse current envelope becomes constant regardless of a phase of the AC output voltage vo, a difference in the switching frequency fs is reduced to obtain high efficiency.

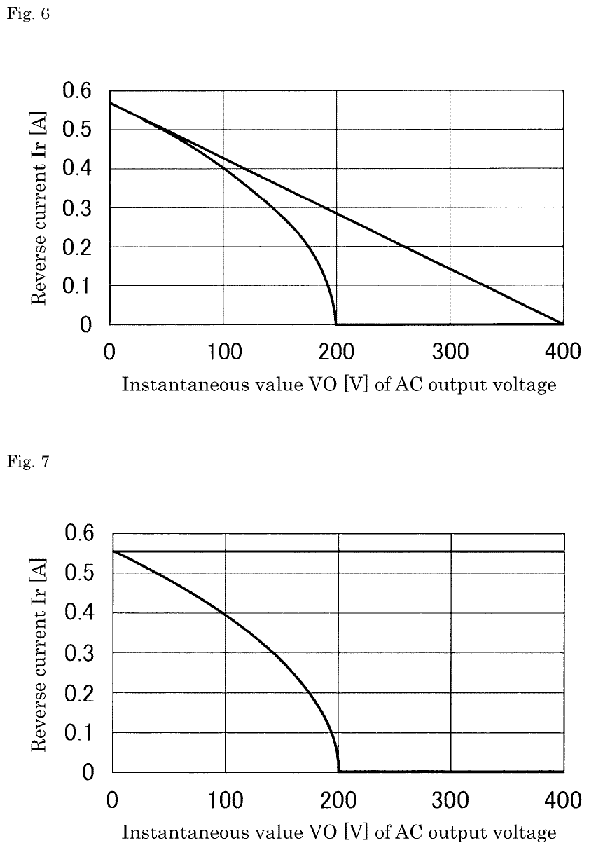

In System 1, with respect to a curve indicating the minimum reverse current Ir with respect to the instantaneous value VO of the AC output voltage vo illustrated in FIG. 3, a line of a linear function as illustrated in FIG. 6 that does not fall below the curve is set. This linear function is expressed by Formula 19 below.

$$\begin{matrix}[ Mathematical formula 19 ] & \\ \text{?} = \sqrt{\frac{C}{L} ( Vin - VO )} & ( Formula 19 )\end{matrix}$$

$$\text{?} \text{indicates text missing or illegible when filed}$$

Formula 19 is simpler than Formula 15 and requires a smaller calculation amount when digital control is performed. In System 1, an amount of the reverse current Ir is determined according to a change in the instantaneous value VO of the AC output voltage vo. Specifically, the smaller the instantaneous value VO, the larger an amount of the reverse current Ir.

The ON time tonQ1 of the first switch Q1 in System 1 is expressed by Formula 20.

$$\begin{matrix}[ Mathematical formula 20 ] & \\ tonQ 1 = \frac{2 L}{Vin - VO} \text{?} + 2 \sqrt{LC} & ( Formula 20 )\end{matrix}$$

$$\text{?} \text{indicates text missing or illegible when filed}$$

The ON time tonQ2 of the second switch Q2 in System 1 is expressed by Formula 21.

$$\begin{matrix}[ Mathematical formula 21 ] & \\ tonQ 2 = \frac{Vin - VO}{VO} tonQ 1 & ( Formula 21 )\end{matrix}$$

Further, the dead time tdead from when the second switch Q2 is turned off to when the first switch Q1 is turned on is expressed by Formula 22 from Formulas 7 and 19.

$$\begin{matrix}[ Mathematical formula 22 ] & \\ \text{?} dead = \sqrt{LC} ( \text{?} - ta \text{?} \frac{Vin - VO}{VO} ) & ( Formula 22 )\end{matrix}$$

$$\text{?} \text{indicates text missing or illegible when filed}$$

Dead time from when the first switch Q1 is turned off to when the second switch Q2 is turned on may be omitted in the principle of synchronous rectification. Therefore, the reciprocal of the sum of Formulas 20, 21, and 22 is the switching frequency fs in System 1.

In System 2, with respect to a curve indicating the reverse current Ir with respect to the instantaneous value VO of the AC output voltage vo illustrated in FIG. 3, a straight line as illustrated in FIG. 7 that does not fall below the curve is set. This straight line is expressed by Formula 23 below.

$$\begin{matrix}[ Mathematical formula 23 ] & \\ \text{?} = \sqrt{\frac{C}{L}} Vin & ( Formula 23 )\end{matrix}$$

$$\text{?} \text{indicates text missing or illegible when filed}$$

In Formula 23 of System 2, since the reverse current Ir has a constant value, calculation of a value of the reverse current Ir can be further simplified then Formula 19 of System 1.

The ON time tonQ1 of the first switch Q1 in System 2 is expressed by Formula 24.

$$\begin{matrix}[ Mathematical formula 24 ] & \\ tonQ 1 = \frac{2 L}{Vin - VO} \text{?} O + \frac{2 Vin \sqrt{LC}}{Vin - VO} & ( Formula 24 )\end{matrix}$$

$$\text{?} \text{indicates text missing or illegible when filed}$$

The ON time tonQ2 of the second switch Q2 in System 2 is expressed by (Formula 25).

$$\begin{matrix}[ Mathematical formula 25 ] & \\ tonQ 2 = \frac{Vin - VO}{VO} \text{?} onQ 1 & ( Formula 25 )\end{matrix}$$

$$\text{?} \text{indicates text missing or illegible when filed}$$

Further, the dead time tdead from when the second switch Q2 is turned off to when the first switch Q1 is turned on is expressed by Formula 26 from Formulas 7 and 23.

$$\begin{matrix}[ Mathematical formula 26 ] & \\ \text{?} dead = \sqrt{LC} ( \text{?} - ta \text{?} \frac{Vin}{VO} ) & ( Formula 26 )\end{matrix}$$

$$\text{?} \text{indicates text missing or illegible when filed}$$

Dead time from when the first switch Q1 is turned off to when the second switch Q2 is turned on may be omitted in the principle of synchronous rectification. Therefore, the reciprocal of the sum of Formulas 24, 25, and 26 is the switching frequency fs in System 2.

Since the linear function and the straight line in FIGS. 6 and 7 both indicate a reverse current mount included in the zero voltage switching (ZVS) region in FIG. 3, a reverse current amount satisfying zero voltage switching is obtained from Formulas 19 and 23.

The curve in FIG. 3 is a boundary line that separates a non-zero voltage switching region and a zero voltage switching region. In System 1 and System 2 in which the reverse current Ir larger than this curve is given, in order to maintain AC output current as indicated by the broken line in FIG. 4, it is necessary to increase peak current as much as increase in the reverse current Ir. That is, it is necessary to increase the ON time tonQ1 of the first switch Q1. Along with this, the on time tonQ2 of the second switch Q2 also increases, so that the switching frequency fs is reduced. An effect of reduction of a switching loss due to decrease in the switching frequency fs exceeds an effect of increase in a switching loss due to increase in peak current.

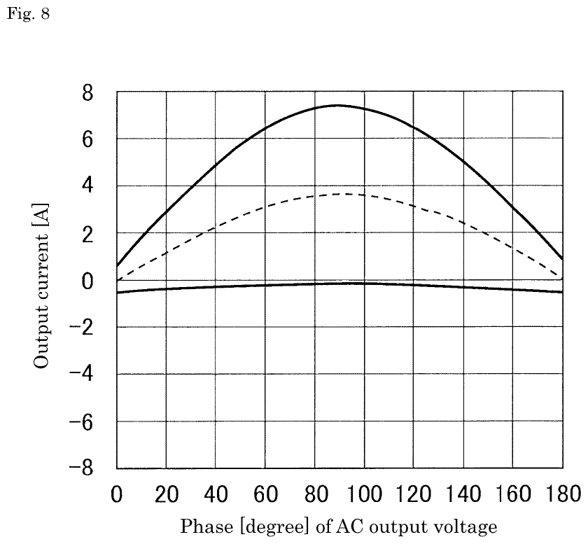

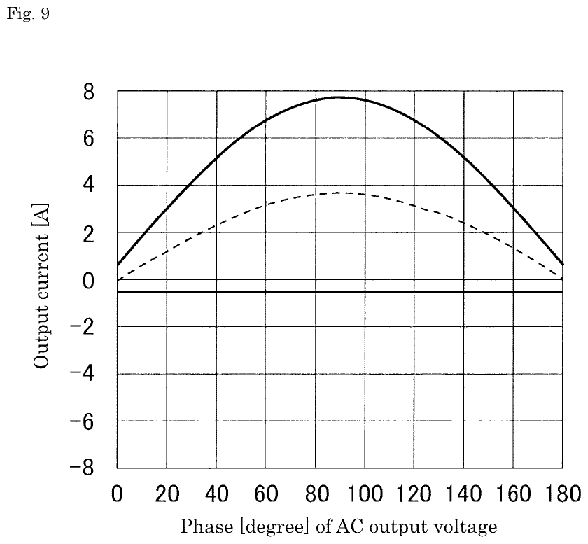

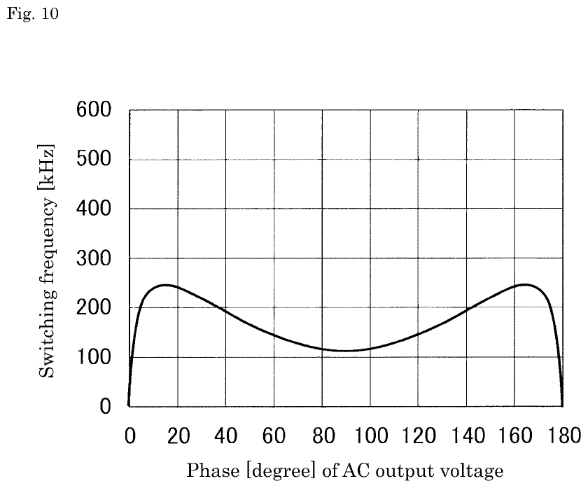

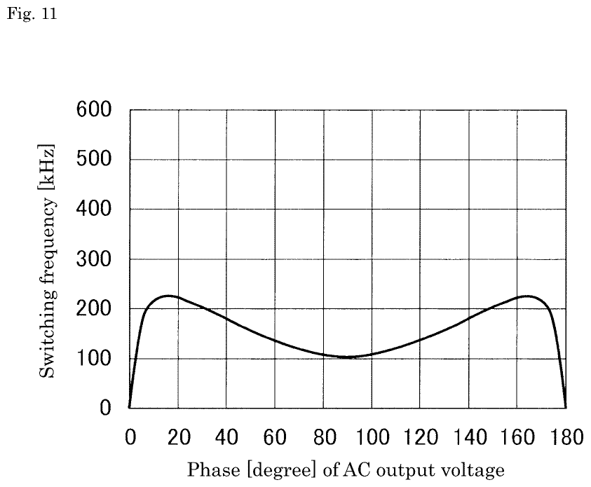

FIG. 8 illustrates a current envelope (solid line) and AC output current (broken line) with respect to a phase of the AC output voltage vo in an inverter circuit employing System 1. FIG. 9 illustrates a current envelope (solid line) and AC output current (broken line) with respect to a phase of the AC output voltage vo in an inverter circuit employing System 2. FIG. 10 illustrates a relationship between a phase of the AC output voltage vo and the switching frequency fs in an inverter circuit employing System 1. FIG. 11 illustrates a relationship between a phase of AC output voltage and the switching frequency fs in an inverter circuit employing System 2.

Comparing FIG. 6 (System 1) with FIG. 7 (System 2), a reverse current amount in the entire phase range of the AC output voltage is larger in FIG. 7 (System 2). For this reason, a peak of the current envelope in FIG. 9 (System 2) is slightly larger than a peak of the current envelope in FIG. 8 (System 1) to maintain the AC output current of the broken line. However, a peak of the switching frequency fs is lower in FIG. 11 (System 2) than in FIG. 10 (System 1). Further, in both of FIG. 10 (System 1) and FIG. 11 (System 2), a peak of the switching frequency fs can be sufficiently reduced as compared with FIG. 5.

Use of System 1 and System 2 will be described below.

In System 1, while the instantaneous value VO of the AC output voltage vo is sampled every time the switches Q1 and Q2 are switched, an amount of the reverse current Ir, ON time of the switches Q1 and Q2, and the like are calculated.

System 2 is suitable for a case where the switches Q1 and Q2 are further subjected to high-frequency switching, a case where an inverter circuit is digitally controlled using a low-grade microcomputer or a digital signal processor (DSP), or the like. As in System 2, when the reverse current Ir is set to a fixed value equal to or more than a certain value of Formula 23 over the entire phase period of the AC output voltage vo, even if there is variation in elements and the like used in an inverter circuit, a peak of a current envelope (switching current) and the switching frequency fs do not change so much as to affect efficiency, and zero voltage switching can be reliably performed. That is, in System 2, it is not necessary to set a strict value to the reverse current Ir as compared with System 1.

Next, System 3 will be described. In System 3, by adding a harmonic component of the frequency fo of the AC output voltage vo to a fixed value equal to or more than a certain value of Formula 23 to the reverse current Ir, it is possible to provide an inverter circuit in which magnitude of the switching frequency fs hardly changes.

In System 3, the reverse current Ir as shown in Formula 27 is set.

$$\begin{matrix}[ Mathematical formula 27 ] & \\ \text{?} = \sqrt{\frac{C}{L}} ( Vin + β ) & ( Formula 27 )\end{matrix}$$

$$\text{?} \text{indicates text missing or illegible when filed}$$

Here, β is a harmonic component of three times the AC output voltage vo alternating at the angular frequency ωo=2πfo. The component β may include not only a harmonic component three times the AC output voltage vo but also a high-order harmonic component obtained by multiplication by odd numbers, such as five times and seven times.

The ON time tonQ1 of the first switch Q1 in System 3 is expressed by (Formula 28).

$$\begin{matrix}[ Mathematical formula 28 ] & \\ tonQ 1 = \frac{2 L}{Vin - VO} \text{?} O + \frac{2 ( Vin + β ) \sqrt{LC}}{Vin - VO} & ( Formula 28 )\end{matrix}$$

$$\text{?} \text{indicates text missing or illegible when filed}$$

The ON time tonQ2 of the second switch Q2 in System 3 is expressed by (Formula 29).

$$\begin{matrix}[ Mathematical formula 29 ] & \\ tonQ 2 = \frac{Vin - VO}{VO} \text{?} onQ 1 & ( Formula 29 )\end{matrix}$$

$$\text{?} \text{indicates text missing or illegible when filed}$$

Other formulas are similar to those of System 2, and thus are omitted.

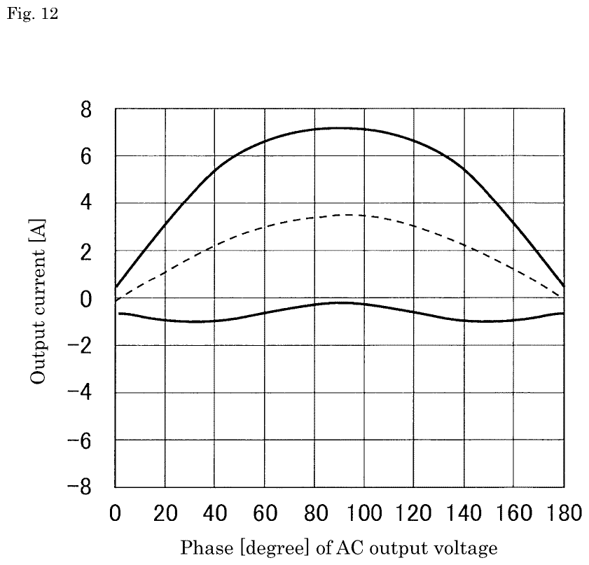

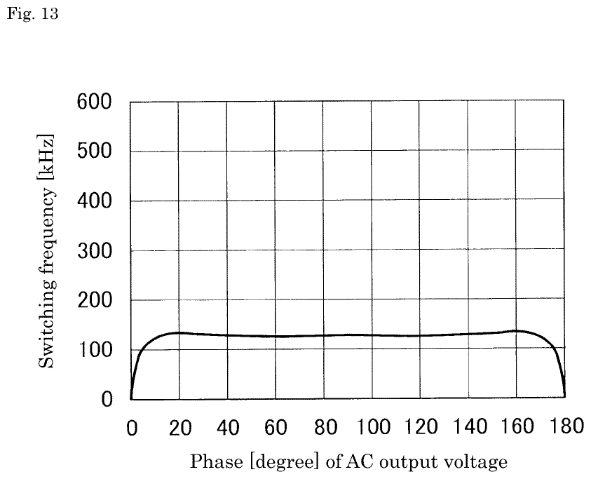

FIG. 12 illustrates, as β of Formula 27, a relationship between a phase of the AC output voltage vo in a case where a third harmonic component is added to the frequency fo of the AC output voltage vo, an envelope (solid line) of switching current, and AC output current (broken line). As described above, in System 3, since a peak of switching current does not increase so much, high efficiency can be expected. FIG. 13 is a diagram illustrating a relationship between a phase of the AC output voltage vo in a case where a third harmonic component of the frequency fo of the AC output voltage vo is added as β in Formula 27 and the switching frequency fs in an inverter circuit employing System 3. It can be seen from FIG. 13 that there is almost no change in the switching frequency fs. In the inverter circuit of System 3, it is easy to take measures against noise such as radio interference (EMI). Further, by adding not only a harmonic component three times the AC output voltage vo but also a high-order harmonic component obtained by multiplication by odd numbers, such as five times and seven times to β, the switching frequency fs becomes a flat shape with respect to a phase, and the switching frequency fs further decreases, so that a switching loss can be further reduced.

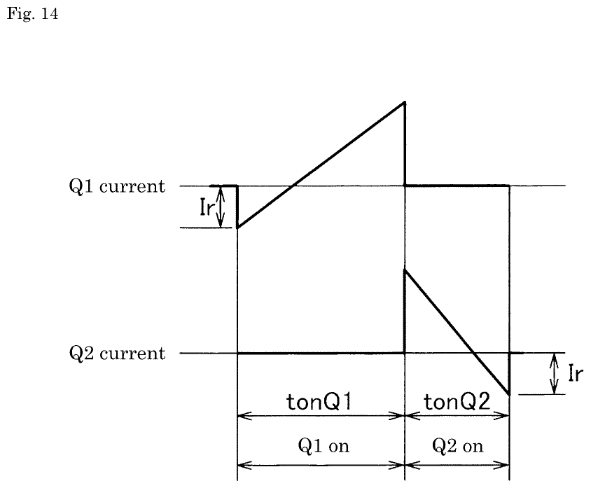

FIG. 14 is a time chart illustrating a waveform of switching current flowing through the first switch Q1 and the second switch Q2 when on and off of the control switch (first switch) Q1 and the synchronous rectification switch (second switch) Q2 are switched as in System 1, System 2, and System 3.

Specifically, the switches Q1 and Q2 are controlled as described below. First, after the second switch Q2 is turned on, when the ON time tonQ2 of the second switch Q2 elapses and current reaches the set reverse current amount Ir, the second switch Q2 is turned off. Then, after the dead time tdead, the first switch Q1 is turned on again, and when the ON time tonQ1 of the first switch Q1 elapses, the first switch Q1 is turned off, and the second switch Q2 is turned on again. Note that the dead time tdead is extremely short as compared with the ON time tonQ1 of the first switch Q1 and the ON time tonQ2 of the second switch Q2, and thus is omitted in FIG. 14.

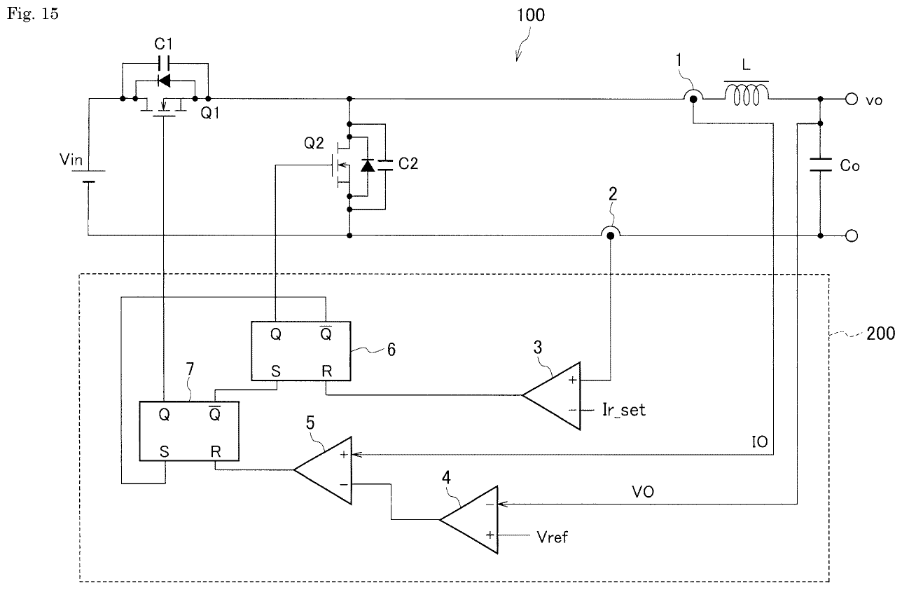

An embodiment of an inverter circuit capable of achieving System 1, System 2, and System 3 is illustrated in FIGS. 15 to 18.

### First Embodiment

An inverter circuit 100 according to a first embodiment will be described with reference to FIG. 15.

The inverter circuit 100 outputs only positive polarity of the AC output voltage vo.

In the inverter circuit 100, a series circuit of the control switch (first switch) Q1 and the synchronous rectification switch (second switch) Q2 is connected in parallel to the DC voltage (DC power supply) Vin. In the first embodiment, an N-channel MOFET is used for the first switch Q1 and the second switch Q2. A first capacitor C1 is connected in parallel to the first switch Q1. A second capacitor C2 is connected in parallel to the second switch Q2. The capacitors C1 and C2 may be parasitic capacity of the switches Q1 and Q2.

One end of the reactor L is connected to a connection point between the first switch Q1 and the second switch Q2. The AC output voltage vo is output via the output capacitor Co connected between another end of the reactor L and a negative electrode (power supply line) of the DC voltage Vin. The turning on and off of the first switch Q1 and the second switch Q2 are controlled by a control circuit 200.

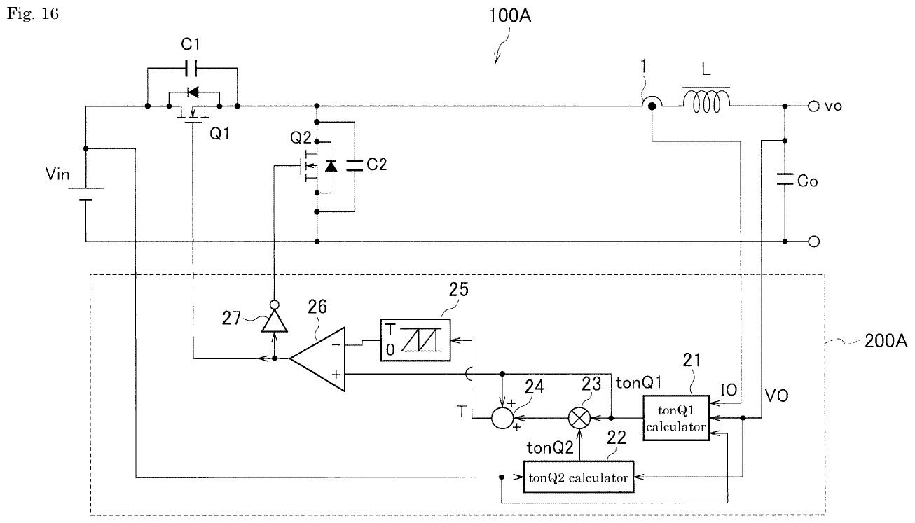

The control circuit 200 includes an error amplifier 4, comparators 3 and 5, and RS flip-flop circuits 6 and 7. Since the control circuit 200 actually performs digital control based on a computer program, a circuit diagram of the control circuit 200 is a conceptual diagram of digital control (the same applies to FIGS. 16 to 18). The error amplifier 4 amplifies error voltage between the instantaneous value VO of the AC output voltage vo and reference voltage Vref, and outputs the amplified error voltage to an inverting input terminal of the comparator 5. A current sensor 1 detects the instantaneous value IO of the current io flowing through a power supply line on the anode side of the inverter circuit 100.

When error voltage from the error amplifier 4 is less than voltage based on the instantaneous value IO of the current io detected by the current sensor 1, the comparator 5 outputs a high level to a reset terminal R of the RS flip-flop circuit 7. At this time, since a low level is output from an output terminal Q of the RS flip-flop circuit 7, the first switch Q1 is turned off. Since a high level is output from an inverting output terminal of the RS flip-flop circuit 7 to a set terminal S of the RS flip-flop circuit 6, the second switch Q2 is turned on. In this way, as the control circuit 200 alternately turns on and off the first switch Q1 and the second switch Q2, it is possible to perform control such that the instantaneous value VO of the AC output voltage vo and the instantaneous value IO of the current io flowing through a power supply line on the anode side of the inverter circuit 100 become predetermined values.

By turning on the first switch Q1, current flows in a loop of Vin→Q1→L→Co→Vin, and the reactor L is excited. Then, when the first switch Q1 is turned off and the second switch Q2 is turned on, excitation of the reactor L is reset by current flowing in a loop of L→Co→Q2→L. When current flowing through the second switch Q2 becomes zero, reverse current flows in a loop of Co→L→Q2→Co, and the reactor L starts to be excited in a reverse direction. This is a state in which switching current flowing through the second switch Q2 is reverse current flowing in a negative direction in FIG. 14, and a value at which an absolute value of the reverse current becomes maximum is referred to as the “reverse current Ir”.

When the reverse current Ir detected by a current sensor 2 for reverse current detection connected to a power supply line on the negative electrode side of the inverter circuit 100 reaches a set value Ir_set of the reverse current Ir, the comparator 3 outputs a high level to the reset terminal R of the RS flip-flop circuit 6, and a low level is output from the output terminal Q of the RS flip-flop circuit 6, so that the second switch Q2 is turned off. Since a high level is output from an inverting output terminal of the RS flip-flop circuit 6 to the set terminal S of the RS flip-flop circuit 7, the first switch Q1 is turned on. Here, by setting the set value Ir_set of the reverse current Ir to a value of the reverse current Ir of any of System 1 (Formula 19), System 2 (Formula 23), and System 3 (Formula 27) or a value equivalent to them, it is possible to support any of System 1, System 2, and System 3. In Formula 19, Formula 23, and Formula 27, the capacitor may have a value C=C1+C2.

The current sensor 1 and the current sensor 2 may be combined into one current sensor. In a case where the current sensors are combined into one current sensor, the instantaneous value IO of current and the reverse current Ir are in opposite directions, and thus it is necessary to monitor each of them.

For simplification of description, the dead time tdead from when the second switch Q2 is turned off to when the first switch Q1 is turned on is omitted.

As described above, the inverter circuit 100 according to the first embodiment operates according to any of System 1, System 2, and System 3 by setting the set value Ir_set of reverse current of the comparator 3 to a value of the reverse current Ir of any of Formula 19 (System 1), Formula 23 (System 2), and Formula 27 (System 3) or a value equivalent to the above value.

Therefore, according to the inverter circuit 100 according to the first embodiment, zero voltage switching can be reliably performed in all phases of the AC output voltage vo, that is, in the entire range of the instantaneous value VO of the AC output voltage vo.

### Second Embodiment

An inverter circuit 100A according to a second embodiment will be described with reference to FIG. 16.

Similarly to the inverter circuit 100 according to the first embodiment, the inverter circuit 100A also outputs only positive polarity of the AC output voltage vo.

In the inverter circuit 100A, the current sensor 2 for detecting reverse current is omitted from the inverter circuit 100 according to the first embodiment illustrated in FIG. 15, and the control circuit 200A calculates time to reach the reverse current Ir and performs zero voltage switching. Other configurations of the inverter circuit 100A are similar to those of the inverter circuit 100 according to the first embodiment.

In order to calculate time to reach the reverse current Ir, it is necessary to obtain the ON time tonQ1 of the first switch Q1 and the ON time tonQ2 of the second switch Q2. The ON time tonQ1 of the first switch Q1 is calculated based on the DC input voltage Vin, the instantaneous value VO of the AC output voltage vo, and the instantaneous value IO of the AC output current io as shown in Formula 20 (System 1), Formula 24 (System 2), and Formula 28 (System 3). The ON time tonQ2 of the second switch Q2 is calculated based on the DC input voltage Vin, the instantaneous value VO of the AC output voltage vo, and the ON time tonQ1 of the first switch Q1 as shown in Formula 21 (System 1), Formula 25 (System 2), and Formula 29 (System 3).

For this reason, in the second embodiment, the control circuit 200A includes a tonQ1 calculator 21 for calculating the ON time tonQ1 of the first switch Q1 and a tonQ2 calculator 22 for calculating the ON time tonQ2 of the second switch Q2.

The tonQ1 calculator 21 receives input of the instantaneous value IO of the current io flowing through a power supply line on the anode side of the inverter circuit 100 detected by the current sensor 1, the instantaneous value VO of the AC output voltage vo of the inverter circuit 100, and the DC input voltage Vin, and calculates and outputs the ON time tonQ1 of the first switch Q1 by any of Formula 20 (System 1), Formula 24 (System 2), and Formula 28 (System 3).

The tonQ2 calculator 22 receives input of the instantaneous value VO of the AC output voltage vo of the inverter circuit 100 and the DC input voltage Vin, and calculates and outputs (Vin-VO)/VO, which is a coefficient of Formula 21 (System 1) and Formula 25 (System 2), and a multiplier 23 further multiplies output of the tonQ2 calculator 22 and output of the tonQ1 calculator 21, so that the ON time tonQ2 of the second switch Q2 is calculated and output.

Further, an adder 24 adds the calculated ON time tonQ1 of the first switch Q1 and the calculated ON time tonQ2 of the second switch Q2, so that the switching cycle T is calculated.

The switching cycle T calculated by the adder 24 is input to a sawtooth wave generation circuit 25. The sawtooth wave generation circuit 25 outputs a sawtooth wave that changes in height according to a value of the switching cycle T. A sawtooth wave output from the sawtooth wave generation circuit 25 and the ON time tonQ1 of the first switch Q1 calculated by the tonQ1 calculator 21 are input to a comparator 26. On and off of the first switch Q are switched by output of the comparator 26, and on and off of the second switch Q2 are switched by a signal obtained by inverting output of the comparator 26 by an inversion circuit 27. Since the ON time tonQ1 calculated by any of Formula 20 (System 1), Formula 24 (System 2), and Formula 28 (System 3) depends on the reverse current Ir, the reverse current Ir is also calculated at the same time.

For simplification of description, the dead time tdead from when the second switch Q2 is turned off to when the first switch Q1 is turned on is omitted.

As described above, in an inverter circuit 100B according to the second embodiment, the tonQ1 calculator 21 sets the ON time tonQ1 calculated by any of Formula 20 (System 1), Formula 24 (System 2), and Formula 28 (System 3), and the tonQ2 calculator 22 sets the ON time tonQ2 calculated by Formula 21 (Systems 1, 2, and 3). By the above, operation is performed by any of System 1, System 2, and System 3.

Therefore, also in the inverter circuit 100A according to the second embodiment, zero voltage switching can be reliably performed in all phases of the AC output voltage vo, that is, in the entire range of the instantaneous value VO of the AC output voltage vo.

### Third Embodiment

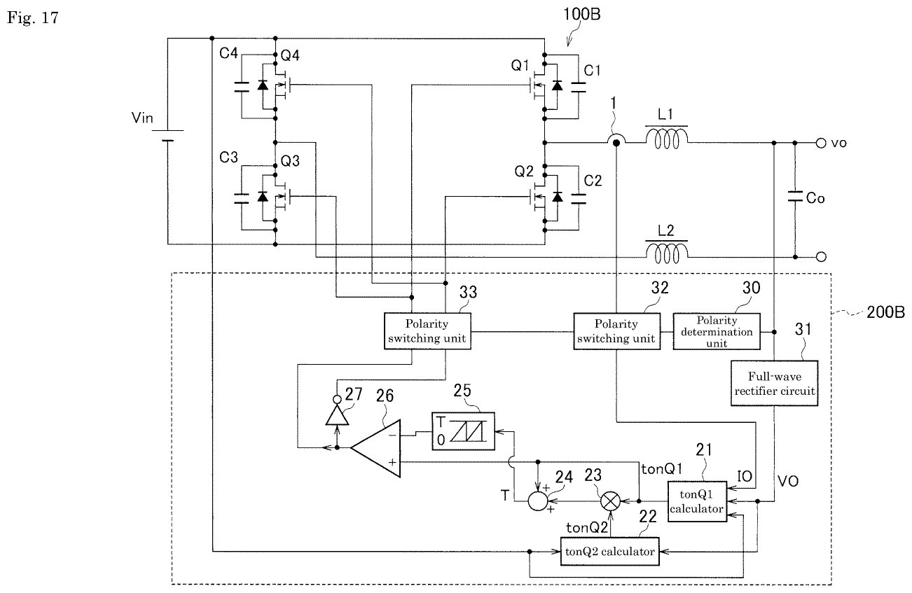

The inverter circuit 100B according to a third embodiment will be described with reference to FIG. 17.

The AC output voltage vo of the inverter circuit 100A according to the second embodiment is output having only positive polarity, whereas the AC output voltage vo of the inverter circuit 100B according to the third embodiment is different in that both positive and negative polarities are output.

In the inverter circuit 100B according to the third embodiment, a series circuit including the first switch Q1 and the second switch Q2 and a series circuit including a third switch Q3 and a fourth switch are connected in parallel to the DC input voltage Vin. In the third embodiment, an N-channel MOFET is used for the switches Q1 to Q4. A first capacitor C1 is connected in parallel to the first switch Q1. A second capacitor C2 is connected in parallel to the second switch Q2. A third capacitor C3 is connected in parallel to the third switch Q3. A fourth capacitor C4 is connected in parallel to a fourth switch Q4. Note that the capacitors C1 to C4 may be parasitic capacity of the switches Q1 to Q4.

One end of a first reactor L1 is connected to a connection point between the first switch Q1 and the second switch Q2. One end of a second reactor L2 is connected to a connection point between the third switch Q3 and the fourth switch Q4. The AC output voltage vo is output via the output capacitor Co connected between another end of the first reactor L1 and another end of the second reactor L2. Values of inductance the first reactor L1 and the second reactor L2 are L1=L2=L/2. On and off of the switches Q1 to Q4 are controlled by a control circuit 200B.

The control circuit 200B performs switching of the first switch Q1 and the third switch Q3 simultaneously, and performs switching of the second switch Q2 and the fourth switch Q4 simultaneously, that is, performs control of a full-bridge type inverter circuit in which diagonal switches are simultaneously switched.

When the AC output voltage vo is in a half cycle of positive polarity, the first switch Q1 and the third switch Q3 serve as control switches, and the second switch Q2 and the fourth switch Q4 serve as synchronous rectification switches. Further, when the AC output voltage vo is in a half cycle of negative polarity, the second switch Q2 and the fourth switch Q4 serve as control switches, and the first switch Q1 and the third switch Q3 serve as synchronous rectification switches.

The control circuit 200B includes a polarity determination unit 30, a full-wave rectifier circuit 31, polarity switching units 32 and 33, the tonQ1 calculator 21, the tonQ2 calculator 22, the multiplier 23, the adder 24, the sawtooth wave generation circuit 25, the comparator 26, and the inversion circuit 27.

Configurations and operation of the tonQ1 calculator 21, the tonQ2 calculator 22, the multiplier 23, the adder 24, the sawtooth wave generation circuit 25, the comparator 26, and the inversion circuit 27 of the control circuit 200B illustrated in FIG. 17 are the same as those of the second embodiment illustrated in FIG. 16, and thus, description of these will be omitted here.

The polarity determination unit 30 determines positive or negative polarity of the AC output voltage vo, and outputs positive or negative polarity to the polarity switching units 32 and 33. The full-wave rectifier circuit 31 full-wave rectifies the AC output voltage vo, that is, inputs the instantaneous value VO of the AC output voltage vo inverted to positive polarity to the tonQ1 calculator 21 when the AC output voltage vo has negative polarity.

In a case where the instantaneous value IO of the current io flowing through the anode side of the inverter circuit 100 detected by the current sensor 1 is positive, the polarity switching unit 32 inputs the value as it is to the tonQ1 calculator 21, and in a case where the instantaneous value IO is negative, the polarity switching unit 32 inverts the polarity and inputs a value as a positive value to the tonQ1 calculator 21.

In a case where polarity of the AC output voltage vo determined by the polarity determination unit 30 is positive, the polarity switching unit 33 switches the first switch Q1 and the third switch Q3 to control switches, and switches the second switch Q2 and the fourth switch Q4 to synchronous rectification switches. In a case where polarity of the AC output voltage vo is negative, the polarity switching unit 33 switches the second switch Q2 and the fourth switch Q4 to control switches, and switches the first switch Q1 and the third switch Q3 to synchronous rectification switches.

That is, in a case where polarity of the AC output voltage vo determined by the polarity determination unit 30 is positive, the polarity switching unit 33 switches on and off of the first switch Q1 and the third switch Q3 by output of the comparator 26, and switches on and off of the second switch Q2 and the fourth switch Q4 by output of the inversion circuit 27. On the other hand, in a case where polarity of the AC output voltage vo determined by the polarity determination unit 30 is negative, the polarity switching unit 33 switches on and off of the second switch Q2 and the fourth switch Q4 by output of the comparator 26, and switches on and off of the first switch Q1 and the third switch Q3 by output of the inversion circuit 27.

More specifically, in a half cycle in which the AC output voltage vo has positive polarity, first, the first switch Q1 and the third switch Q3, which are control switches, are turned on, and the second switch Q2 and the fourth switch Q4, which are synchronous rectification switches, are turned off, so that current flows in a positive direction in a loop of Vin→Q1→L1→Co→L2→Q3→Vin, and the reactors L1 and L2 are excited. Next, the first switch Q1 and the third switch Q3, which are control switches, are turned off, and the second switch Q2 and the fourth switch Q4, which are synchronous rectification switches, are turned on, so that excitation of the reactors L1 and L2 is reset in a loop of L1→Co→L2→Q4→Vin→Q2→L1.

Further, in a half cycle in which the AC output voltage vo has negative polarity, first, the second switch Q2 and the fourth switch Q4, which are control switches, are turned on, and the first switch Q1 and the third switch Q3, which are synchronous rectification switches, are turned off, so that current flows in a negative direction in a loop of Vin→Q4→L2→Co→L1→Q2→Vin, and the reactors L1 and L2 are excited. Next, the second switch Q2 and the fourth switch Q4, which are control switches, are turned off, and the first switch Q1 and the third switch Q3, which are synchronous rectification switches, are turned on, so that excitation of the reactors L1 and L2 is reset in a loop of L2→Co→L1→Q1→Vin→Q3→L2.

A value of the capacitor C is preferably C=C2+C4 when the AC output voltage vo is in a half cycle of positive polarity, and C=C1+C3 when the AC output voltage vo is in a half cycle of negative polarity. A value of the inductance L is L=L1+L2.

As described above, also in the inverter circuit 100B according to the third embodiment, the ON time tonQ1 calculated by any of Formula 20 (System 1), Formula 24 (System 2), and Formula 28 (System 3) is set by the tonQ1 calculator 21, and the ON time tonQ2 calculated by Formula 21 (Systems 1, 2, and 3) is set by the tonQ2 calculator 22, so that the value can be set to a value of the reverse current Ir of any of Formula 19 (System 1), Formula 23 (System 2), and Formula 27 (System 3). For this reason, operation can be performed by any of System 1, System 2, and System 3.

Therefore, also in the inverter circuit 100B according to the third embodiment, zero voltage switching can be reliably performed in all phases of the AC output voltage vo, that is, in the entire range of the instantaneous value VO of the AC output voltage vo.

### Fourth Embodiment

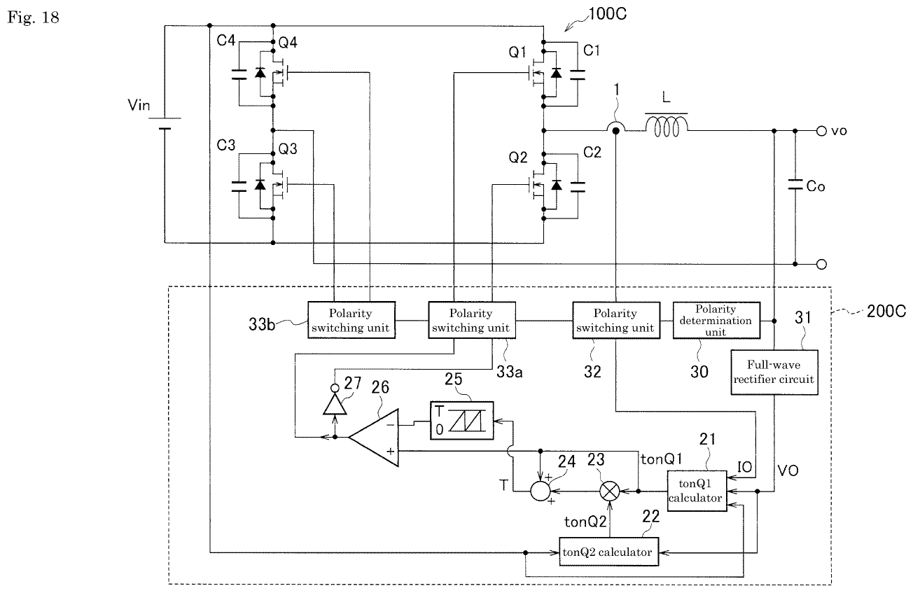

An inverter circuit 100C according to a fourth embodiment will be described with reference to FIG. 18.

The inverter circuit 100C according to the fourth embodiment illustrated in FIG. 18 is a totem pole type inverter circuit in which zero voltage switching can be performed at AC output voltage of all ranges.

In the inverter circuit 100C according to the fourth embodiment, a series circuit including the first switch Q1 and the second switch Q2 and a series circuit including a third switch Q3 and a fourth switch are connected in parallel to the DC input voltage Vin. In the fourth embodiment, an N-channel MOFET is used for the switches Q1 to Q4. A first capacitor C1 is connected in parallel to the first switch Q1. A second capacitor C2 is connected in parallel to the second switch Q2. A third capacitor C3 is connected in parallel to the third switch Q3. A fourth capacitor C4 is connected in parallel to a fourth switch Q4. Note that the capacitors C1 to C4 may be parasitic capacity of the switches Q1 to Q4.

One end of the reactor L is connected to a connection point between the first switch Q1 and the second switch Q2. The AC output voltage vo is output via the output capacitor Co connected between another end of the reactor L and a connection point of the third switch Q3 and the fourth switch Q4. On and off of the switches Q1 to Q4 are controlled by a control circuit 200C.

In a half cycle in which the AC output voltage vo has positive polarity, the first switch Q1 is a control switch, the second switch Q2 is a synchronous rectification switch, the third switch Q3 is turned on, and the fourth switch Q4 is turned off. In a half cycle in which the AC output voltage vo has negative polarity, the second switch Q2 is a control switch, the first switch Q1 is a synchronous rectification switch, the fourth switch Q4 is turned on, and the third switch Q3 is turned off. That is, the inverter circuit 100C according to the fourth embodiment is a totem pole type inverter circuit.

The control circuit 200C includes the polarity determination unit 30, the full-wave rectifier circuit 31, the polarity switching units 32, 33a, and 33b, the tonQ1 calculator 21, the tonQ2 calculator 22, the multiplier 23, the adder 24, the sawtooth wave generation circuit 25, the comparator 26, and the inversion circuit 27.

Configurations and operation of the tonQ1 calculator 21, the tonQ2 calculator 22, the multiplier 23, the adder 24, the sawtooth wave generation circuit 25, the comparator 26, the inversion circuit 27, the polarity discrimination unit 30, the full-wave rectifier circuit 31, and the polarity switching unit 32 of the control circuit 200C illustrated in FIG. 18 are the same as those of the third embodiment illustrated in FIG. 17, and thus, description of these is omitted here.

In a case where polarity of the AC output voltage vo determined by the polarity determination unit 30 is positive, the polarity switching unit 33a switches the first switch Q1 to a control switch, and switches the second switch Q2 to a synchronous rectification switch. In a case where polarity of the AC output voltage vo is negative, the polarity switching unit 33a switches the second switch Q2 to a control switch, and switches the first switch Q1 to a synchronous rectification switch.

That is, in a case where polarity of the AC output voltage vo determined by the polarity determination unit 30 is positive, the polarity switching unit 33a switches on and off of the first switch Q1 by output of the comparator 26, and switches on and off of the second switch Q2 by output of the inversion circuit 27. Further, in a case where polarity of the AC output voltage vo determined by the polarity determination unit 30 is negative, the polarity switching unit 33a switches on and off of the second switch Q2 by output of the comparator 26, and switches on and off of the first switch Q1 by output of the inversion circuit 27.

The polarity switching unit 33b turns on the third switch Q3 and turns off the fourth switch Q4 in a case where polarity of the AC output voltage vo determined by the polarity determination unit 30 is positive, and turns on the fourth switch Q4 and turns off the third switch Q3 in a case where polarity of the AC output voltage vo determined by the polarity determination unit 30 is negative.

More specifically, in a half cycle in which the AC output voltage vo has positive polarity, the first switch Q1, which is a control switch, is turned on and the second switch Q2, which is a synchronous rectification switch, is turned off in a state in which the third switch Q3 is turned on and the fourth switch Q4 is turned off, so that current in a positive direction flows in a loop of Vin→Q1→L→Co→Q3→Vin. In this manner, the reactor L is excited. Next, the first switch Q1, which is a control switch, is turned off, and the second switch Q2, which is a synchronous rectification switch, is turned on, so that current flows in a loop of L→Co→Q3→Q2→L. In this manner, excitation of the reactor L is reset. When current flowing through the second switch Q2 becomes zero, reverse current flows in a loop of Co→L→Q2→Q3→Co, and the reactor L starts to be excited in a reverse direction. This is a state in which current flowing through the second switch Q2 is reverse current flowing in a negative direction in FIG. 14.

Further, in a half cycle in which the AC output voltage vo has negative polarity, the second switch Q2, which is a control switch, is turned on and the first switch Q1, which is a synchronous rectification switch, is turned off in a state in which the fourth switch Q4 is turned on and the third switch Q3 is turned off, so that current in a negative direction flows in a loop of Vin→Q4→Co→L→Q2→Vin. In this manner, the reactor L is excited. Next, the second switch Q2, which is a control switch, is turned off, and the first switch Q1, which is a synchronous rectification switch, is turned on, so that current flows in a loop of L→Q1→Q4→Co→L. In this manner, excitation of the reactor L is reset. When current flowing through the first switch Q1 becomes zero, reverse current flows through a loop of Co→Q4→Q1→L→Co, and the reactor L starts to be excited in a reverse direction. This corresponds to a state in which Q1 and Q2 are exchanged and polarity of current is inverted in FIG. 14.

Further, a value of the capacitor C is set to C=C1+C2+C4 in a half cycle in which the AC output voltage vo has positive polarity, and a value of the capacitor C is set to C=C1+C2+C3 in a half cycle in which the AC output voltage vo has negative polarity, so that calculation can be examined by the calculation formulas derived so far.

As described above, also in the inverter circuit 100C according to the fourth embodiment, the ON time tonQ1 calculated by any of Formula 20 (System 1), Formula 24 (System 2), and Formula 28 (System 3) is set by the tonQ1 calculator 21, and the ON time tonQ2 calculated by Formula 21 (Systems 1, 2, and 3) is set by the tonQ2 calculator 22, so that the value can be set to a value of the reverse current Ir of any of Formula 19 (System 1), Formula 23 (System 2), and Formula 27 (System 3). For this reason, operation can be performed by any of System 1, System 2, and System 3.

Therefore, also in the inverter circuit 100C according to the fourth embodiment, zero voltage switching can be reliably performed in all phases of the AC output voltage vo, that is, in the entire range of the instantaneous value VO of the AC output voltage vo.

1. An inverter circuit capable of converting DC input voltage of a DC power supply into AC output voltage of a predetermined frequency, the inverter circuit comprising:
a series circuit in which a control switch and a synchronous rectification switch are connected in series, the series circuit being connected in parallel to the DC power supply;
a reactor having one end connected to a connection point between the control switch and the synchronous rectification switch;
an output capacitor that is connected between a power supply line of the DC power supply and another end of the reactor and outputs the AC output voltage to both ends; and
a control circuit that performs control of turning off the control switch and turning on the synchronous rectification switch after turning on the control switch for first ON time, and turning off the synchronous rectification switch and turning on the control switch after turning on the synchronous rectification switch for second ON time so as to generate reverse current in the reactor in an entire range of an instantaneous value of the AC output voltage.

2. The inverter circuit according to claim 1, wherein a current value of the reverse current is obtained based on an inductance value of the reactor, a capacitance value of a capacitor connected in parallel to the control switch, a detection value of the DC input voltage, and a detection value of an instantaneous value of the AC output voltage.

3. The inverter circuit according to claim 1, wherein a current value of the reverse current is a fixed value obtained based on an inductance value of the reactor, a capacitance value of a capacitor connected in parallel to the control switch, and a detection value of the DC input voltage.

4. The inverter circuit according to claim 1, wherein a current value of the reverse current is a value obtained by adding a harmonic component of a frequency of the AC output voltage to a fixed value obtained based on an inductance value of the reactor, a capacitance value of a capacitor connected in parallel to the control switch, and a detection value of the DC input voltage.

5. The inverter circuit according to claim 1, wherein the control circuit controls the first ON time and the second ON time so that the reverse current has a predetermined current value based on a detection value of the DC input voltage, a detection value of an instantaneous value of the AC output voltage, and a detection value of the AC output current.

6. The inverter circuit according to claim 1, wherein the control circuit performs control to provide dead time in which both the control switch and the synchronous rectification switch are turned off while the control switch is turned on after the synchronous rectification switch is turned off.

7. The inverter circuit according to claim 2, wherein the capacitor connected in parallel to the control switch is parasitic capacity of the control switch.

8. An inverter circuit capable of converting DC input voltage of a DC power supply into AC output voltage of a predetermined frequency, the inverter circuit comprising:
a first series circuit in which a first switch and a second switch are connected in series, the first series circuit being connected in parallel to the DC power supply;
a second series circuit in which a third switch and a fourth switch are connected in series, the second series circuit being connected in parallel to the DC power supply;
a reactor having one end connected to a connection point between the first switch and the second switch;
an output capacitor that is connected between a connection point between the third switch and the fourth switch and another end of the reactor and outputs the AC output voltage to both ends; and
a control circuit that performs control of turning on the third switch and turning off the fourth switch and, after turning on the first switch as a control switch for first ON time, turning off the first switch and turning on the second switch as a synchronous rectification switch, and, after turning on the second switch for second ON time, turning off the second switch and turning on the first switch in a half cycle in which the AC output voltage is positive, and performs control of turning off the third switch and turning on the fourth switch and, after turning on the second switch as a control switch for first ON time, turning off the second switch and turning on the first switch as a synchronous rectification switch, and, after turning on the first switch for second ON time, turning off the first switch and turning on the second switch in a half cycle in which the AC output voltage is negative so as to generate reverse current in the reactor in an entire range of an instantaneous value of the AC output voltage.

9. The inverter circuit according to claim 8, wherein a current value of the reverse current is obtained based on an inductance value of the reactor, a capacitance value of a capacitor connected in parallel to the control switch, a detection value of the DC input voltage, and a detection value of an instantaneous value of the AC output voltage.

10. The inverter circuit according to claim 8, wherein a current value of the reverse current is a fixed value obtained based on an inductance value of the reactor, a capacitance value of a capacitor connected in parallel to the control switch, and a detection value of the DC input voltage.

11. The inverter circuit according to claim 8, wherein a current value of the reverse current is a value obtained by adding a harmonic component of a frequency of the AC output voltage to a fixed value obtained based on an inductance value of the reactor, a capacitance value of a capacitor connected in parallel to the control switch, and a detection value of the DC input voltage.

12. The inverter circuit according to claim 8, wherein the control circuit controls the first ON time and the second ON time so that the reverse current has a predetermined current value based on a detection value of the DC input voltage, a detection value of an instantaneous value of the AC output voltage, and a detection value of the AC output current.

13. The inverter circuit according to claim 8, wherein the control circuit performs control to provide dead time in which both the control switch and the synchronous rectification switch are turned off while the control switch is turned on after the synchronous rectification switch is turned off.

14. The inverter circuit according to claim 9, wherein the capacitor connected in parallel to the control switch is parasitic capacity of the control switch.
